(19) United States
(12) Patent Application Publication
(10) Pub. No.: US 2019/0347594 A1
(43) Pub. Date: Nov. 14, 2019

(54) TASK GROUP FORMATION USING SOCIAL INTERACTION ENERGY

(71) Applicant: International Business Machines Corporation, Armonk, NY (US)

(72) Inventors: Kelley Anders, East New Market, MD (US); Jeremy R. Fox, Georgetown, TX (US); Liam S. Harpur, Dublin (IE); Jonathan Dunne, Dungarvan (IE)

(73) Assignee: International Business Machines Corporation, Armonk, NY (US)

(21) Appl. No.: 15/976,969

(22) Filed: May 11, 2018

(51) Int. Cl. G06Q 10/06; G06F 17/30; G06N 5/02

(52) U.S. Cl. CPC G06Q 10/06311; G06Q 10/06313; G06N 5/022; G06F 17/30876

(57) ABSTRACT

A prediction model specific to a type of a task in a project is constructed. During an execution of the prediction model, a cadence metric is adjusted to a first value to cause a posterior of the prediction model to converge with a prior of the prediction model. The first value of the cadence metric causes the probability of success of the type of the task to reach a desired value. Profiles of a set of participants is created using historical participation data, the profiles including a cadence profile of each participant in the set of participants. A value in the cadence profile of a selected participant is matched with the first value of the cadence metric. A project planning tool is caused to allocate the selected participant as a resource for the task of the type.

### TECHNICAL FIELD

The present invention relates generally to a method, system, and computer program product for selecting participants for a task. More particularly, the present invention relates to a method, system, and computer program product for task group formation using social interaction energy.

### BACKGROUND

A “task” is a reference to all or a portion of a project. A group of participants contributes efforts, interactions, and teamwork towards obtaining a desired goal of the task.

A participant is a human user who conducts social interactions with other participants on a team, to advance or complete a task assigned to the team. Social interactions include inter-personal communications between two or more participants, and can take the form of written messages, audio or video communications, graphical or textual presentations, or some combination thereof.

Note that a document prepared by a participant for storage or later use by unidentified others is not regarded as a social interaction within the scope of the illustrative embodiments. A social interaction uses two or more participants amongst whom an exchange of a type of communication contemplated herein occurs. For example, a trouble ticket documentation prepared by a participant of a support task is not a social interaction, but an email prepared by a participant for another participant—e.g. a support team manager—is a social interaction. Phone calls, instant messages, and audio/video conferences between participants are some more examples of social interactions that are contemplated within the scope of the illustrative embodiments.

The success of a task is dependent to a significant degree on the social interactivity amongst the participants in the task-group. Generally, participants disconnect or disengage socially from other participants in the task-group due to mismatched personalities of the participants, mismatched expectations of the task and the skills of the participants, inability of the participant to keep with the pace of the task, and many other social reasons.

### SUMMARY

The illustrative embodiments provide a method, system, and computer program product. An embodiment includes a method that constructed a prediction model specific to a type of a task in a project. The embodiment adjusts, during an execution of the prediction model, a cadence metric to a first value, the adjusting causing a posterior of the prediction model to converge with a prior of the prediction model. The embodiment determines that the first value of the cadence metric causes the probability of success of the type of the task to reach a desired value. The embodiment profiles a set of participants using historical participation data, the profiling producing a cadence profile of each participant in the set of participants. The embodiment matches a value in the cadence profile of a selected participant with the first value of the cadence metric. The embodiment causes a project planning tool to allocate the selected participant as a resource for the task of the type.

An embodiment includes a computer usable program product. The computer usable program product includes a computer-readable storage device, and program instructions stored on the storage device.

An embodiment includes a computer system. The computer system includes a processor, a computer-readable memory, and a computer-readable storage device, and program instructions stored on the storage device for execution by the processor via the memory.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for task group formation using social interaction energy in accordance with an illustrative embodiment;

FIG. 4 depicts a block diagram of a detailed set of operations for task group formation using social interaction energy in accordance with an illustrative embodiment; and

FIG. 5 depicts a flowchart of an example process for task group formation using social interaction energy in accordance with an illustrative embodiment.

### DETAILED DESCRIPTION

Project staffing and task-group management is an essential component of the well recognized technological field of project planning tools. The present state of the technology in this field of endeavor has certain drawbacks and limitations. The operations and/or configurations of the illustrative embodiments impart additional or new capabilities to improve the existing technology in the technological field of project planning tools, especially in the area of correctly configuring task-teams.

The illustrative embodiments recognize that the successful completion of a task depends, in a significant part, on not just the knowledge and skills of the participants but also on the fitness of those participants in the amount and type of social interactions that may be needed during the course of the task. It is often observed in projects involving teams of participants that with the passage of time, exhaustion from social interaction sets-in in a participant, and the contributions of that participant deteriorates. The deteriorated social interaction can be observed as a reduction in the frequency, detail, interest, sentiment, and other such factors of the participant's communications. Furthermore, the deteriorating social interaction can have a contagious effect on other participants, whose social interaction also begins to suffer.

The illustrative embodiments recognize that social interactions have a cadence and an intensity. Cadence of a social interaction is a frequency or regularity at which the social interaction occurs over a period. The cadence of a particular social interaction can have different patterns of frequency or regularity during different periods. For example, a participant may engage in social interactions thrice a day for the first two weeks of a task, then once a day for the next two months of the task, followed by five times per day for the last three days of the duration of the task.

An intensity of a social interaction is a measure of force, vigor, diligence, detail, or sentiment of the social interaction. Natural language processing (NLP) techniques can analyze a given social interaction to evaluate an intensity metric of the social interaction. For example, deep parsing in NLP can determine a sentiment, level of engagement, or propensity of the participant towards the subject of the social interaction. The determined sentiment, level of engagement, or propensity can be quantified into a discrete value relative to a chosen scale of values.

In some cases, the intensity of the social interaction is a factor of a size of the contents of the social interaction. For example, the longer the text of a social interaction, the more committed the participant may be to the subject being discussed.

In some cases, the originality of the social interaction is a factor of a size of the contents of the social interaction. For example, the less original the text of a social interaction, e.g., the more the text is cut and pasted from other places, the less committed the participant may be to the subject being discussed.

The illustrative embodiments recognize that cadence and intensity are important factors in selecting the right participants for a task group. Given a task, especially a task that corresponds to a similar task that has been performed before in the same or a different project, the cadence and intensity requirements of the task can be predicted.

The illustrative embodiments also recognize that a participant exhibits similar behavioral characteristics under similar circumstances. Thus, given a group of potential participants, a potential participant's cadence and intensity relative to the type of task being contemplated can be determined from the participant's historical performance with similar tasks.

The illustrative embodiments further recognize that a task's probability of successful completion can be predicted given certain cadence and intensity metrics for the members of the task group. For example, if a task is partially completed, the likelihood of success is a function of success ratio of similar tasks in the past as well as the cadence and intensity of the present team of participants. If the cadence and/or intensity of a participant changes, the likelihood of success of the task also changes. Thus, the illustrative embodiments recognize that actively managing the membership of the task group dynamically during a project based on participant cadence and intensity can improve the task's likelihood of success.

The present state of the technological field of endeavor of project management presently does not include a mechanism to use participant cadence and intensity based task staffing. A need exists for dynamically assessing the suitability of one or more participants and changing the team membership based on the cadence and intensity of participants' social interactions. A need exists that the likelihood of success of tasks in a project plan be improved using cadence and intensity as bases.

The illustrative embodiments recognize that the presently available tools or solutions do not address these needs/problems or provide adequate solutions for these needs/problems. The illustrative embodiments used to describe the invention generally address and solve the above-described problems and other related problems by task group formation using social interaction energy.

An embodiment can be implemented as a combination of certain hardware components and a software application. An implementation of an embodiment, or one or more components thereof, can be configured as a modification of an existing project planning and management application, with a companion software application executing in some combination of (i) the project planning and management application itself, (ii) a data processing system communicating with the project planning and management application over short-range radio or a local area network (LAN), and (iii) a data processing system communicating with the project planning and management application over a wide area network (WAN).

A project planning and management application manages a project plan. The project plan includes one or more tasks. An embodiment selects a task in the project plan. The selected task may have already started, may not have started yet, and may or may not have one or more participants assigned to the task at the time of the selection.

Suppose that the task is of a type. Further suppose that other tasks of the same type have been performed prior to the selected task, in the same or a different project plan. As is generally the case, participants for a task are drawn from a pool of available participants who have previously contributed on other task groups, including but not necessarily on task groups formed for previous tasks of the same type as the task in question.

An embodiment constructs a probability model, which is specific for the type of the task, and which would be suitable for predicting the probability of success of the task. For example, using Bayesian inference, the embodiment computes a “prior” as a probability of success of the task given the historical project data about the successful and unsuccessful previous completions of other tasks of the same type. This “prior” is a probability of a hypothesis—the success of the task of the type—based on historical data available about the success of the tasks of the type, P(H), before any evidence from the current task is considered.

The embodiment computes a “conjugate” as a probability of success of the task given the empirical measured data (evidence) about the task in question. This “conjugate” is represented as a probability based on evidence, P(EH), i.e., probability of observing an evidence given the hypothesis of success of the task. For example, if the task is already in progress, given the cadence metric, intensity metric, degree of completion metric, and other metrics configured for the task, each such metric provides the empirical data, or evidence, for the computation of the conjugate.

The embodiment computes a “posterior” P(HE), i.e., the probability of the hypothesis—the success of the task—given the evidence of current metrics. The Bayesian inference is represented as

$$P ( H \vert E ) = \frac{P ( E \vert H ) \cdot P ( H )}{P ( E )}$$

Even though the representation of Bayesian inference is known, the values in the representation provide the task-type specific model described herein. The embodiment then uses this task-type-specific posterior distribution model iteratively. The posterior computed in one iteration becomes the prior in the next iteration until an exit condition is reached and the iterative process stops.

In each iteration, an embodiment adjusts the evidence. Specifically, the embodiment changes the cadence metric, the intensity metric, or both to determine if the prior and the posterior converge within a tolerance value. When the prior and the posterior in an iteration have converged for some values of the cadence and intensity metrics, the embodiment concludes that the most desirable combination of the cadence and intensity are reached in the model to produce optimal probability of success for the task in question.

An embodiment computes a cadence and intensity profile of a participant using historical user participation data of the participant or a similar participant. For example, if the participant in question is a technical support engineer with x number of years of experience, the historical user participation data of the participant is used to compute how the cadence and/or intensity of the participant has changed over the course of a previous task of the same type as the task in question.

In some cases, the historical user participation data of the particular participant may not be available, or may not be available for a specific type of task. In such cases, the historical user participation data of another participant, e.g., who is also a technical support engineer with x number of years of experience, may be used in a similar manner to compute the cadence and intensity profile of the participant in question.

An embodiment takes the cadence and intensity metric output of the task-type-specific model at the model convergence and defines a tolerance value relative to each of the two metrics. The embodiment selects from a set of participants, that subset of participants in which each participant has a cadence and intensity profile that matches within the respective tolerance the convergence cadence and intensity of the model.

Optionally, an embodiment determines whether a participant selected in the subset is actually available to participate in the task. For example, the embodiment refers the resource commitment data of a project planning tool or a calendaring tool to determine whether the participant is pre-committed to another task. In such a case, the embodiment removes the pre-committed but compatible participant from the subset.

The embodiment selects, from the subset of matching participants, a participant who is available to participate in the task. The embodiment produces an output to the project planning tool. The output from the embodiment comprises a recommendation to use the selected participant in the task to achieve the desired cadence metric, the desired intensity metric, or both for the task, and thereby achieve the optimal probability of success for the task.

The manner of task group formation using social interaction energy described herein is unavailable in the presently available methods in the technological field of endeavor pertaining to project planning tools. A method of an embodiment described herein, when implemented to execute on a device or data processing system, comprises substantial advancement of the functionality of that device or data processing system in optimizing the task group participation such that the group has the converging cadence and intensity for optimal probability of task success according to a task-type-specific prediction model.

The illustrative embodiments are described with respect to certain types of projects, tasks, groups, participants, social interactions, cadence, intensities, tolerances, locations of embodiments, data, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

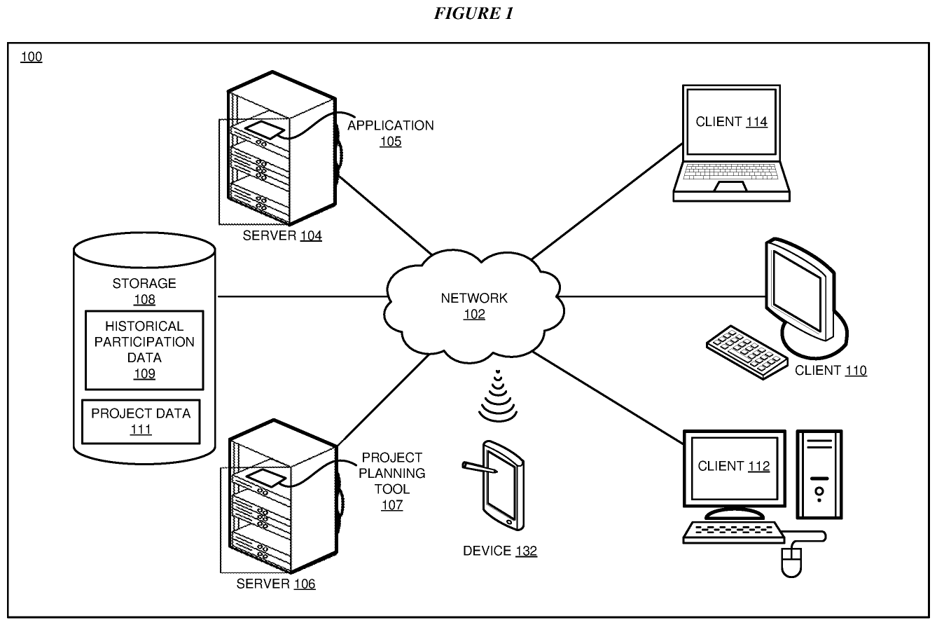

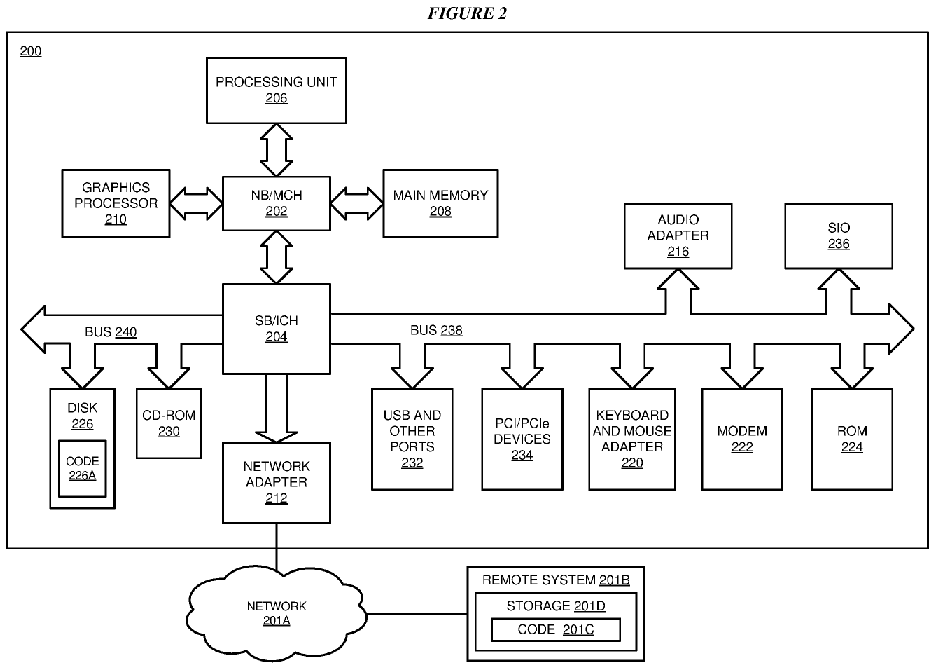

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as examples and not to imply a limitation to a client-server architecture. As another example, an embodiment can be distributed across several data processing systems and a data network as shown, whereas another embodiment can be Implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. Tool 107 is a Project planning and management application with which application 105 interacts as described herein. Repository 108 includes historical participation data 109 of a set of participants. Project data 111 includes historical data of past projects and tasks as well as current evidence data about a current task in a current project as described herein.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

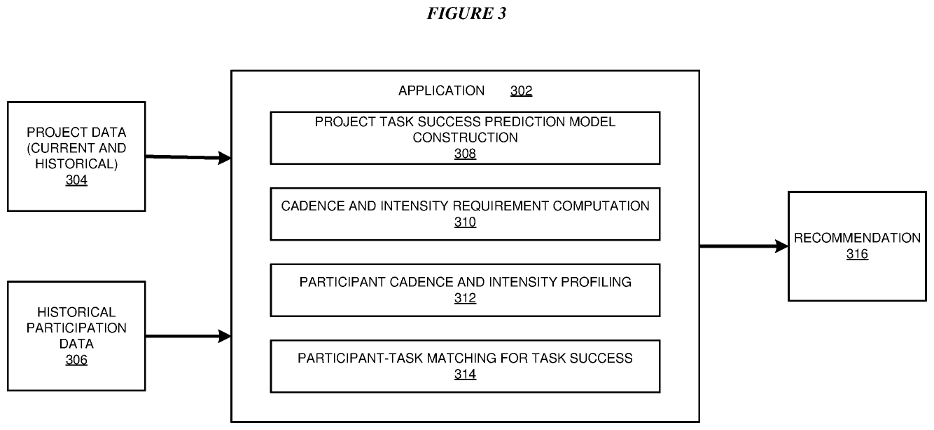

With reference to FIG. 3, this figure depicts a block diagram of an example configuration for task group formation using social interaction energy in accordance with an illustrative embodiment. Application 302 is an example of application 105 in FIG. 1. Project data 304 is an example of project data 111 in FIG. 1. Historical participation data 306 is an example of historical participation data 109 in FIG. 1.

Component 306 of application 302 constructs the model for the predicting the probability of success of a given task of a given type. The model uses historical task performance data from project data 304 in a manner described herein. Component 310 uses the model to compute a cadence and intensity requirement to achieve optimal probability of success for the task.

Component 312 uses historical participation data 306 to construct cadence and intensity profiles of a set of participants. Component 314 matches a participant's cadence and intensity according to the participant's cadence and intensity profile with the desired cadence and intensity according to the model's optimal probability convergence point. Depending on the availability of a selected participant, application 302 outputs the selected participant as recommendation 316 to tool 107. Tool 107 then optionally configures the selected participant to participate in the task for which the model is constructed.

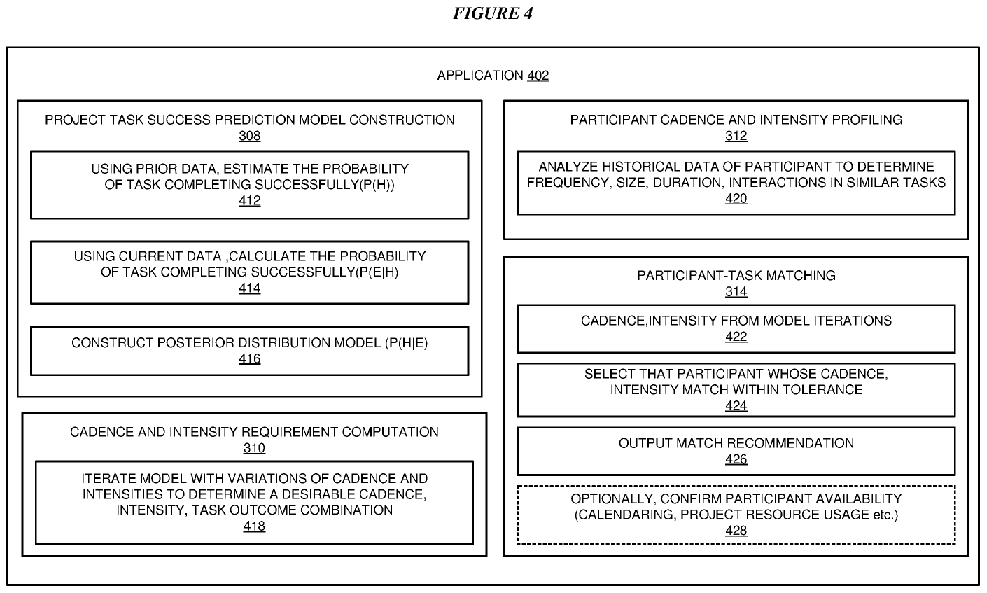

With reference to FIG. 4, this figure depicts a block diagram of a detailed set of operations for task group formation using social interaction energy in accordance with an illustrative embodiment. Application 302 and component 308, 310, 312, and 314 are the same as in FIG. 3.

Component 308 computes a prior P(H) for a specific type of task using historical project data, as described herein (operation 412). Component 308 uses current evidence from the current task in the current project to compute the conjugate (P(EH)) as described herein (operation 414). Component 308 uses the prior and the conjugate to construct the task-type-specific posterior distribution model (operation 416).

Component 310 iteratively executes the model with variations of cadence metric, intensity metric, or both (operation 418). The model execution by component 310 determines a desirable value of the cadence and intensity that yields a convergence between the prior and the posterior, to with, an optimal probability of success of the task type.

Component 312 analyzes the historical participation data of various participants to determine the frequency of social interactions, size, duration, and other features that correspond to the cadence and intensity of social interaction as described herein (operation 420). Operation 420 results in cadence and intensity profiles of the various participants.

Component 314 obtains the cadence and intensity values corresponding to the optimal probability of success, as computed by operation 418 (operation 422). Component 314 selects that participant whose cadence and intensity during a period in the cadence and intensity profile matches the optimal cadence and intensity computed in operation 418 (operation 424). The match uses a tolerance value as described herein.

In one embodiment, component 314 outputs the matching participant as a recommended resource for the task (operation 426). In another embodiment, component 314 optionally confirms whether the selected participant is available for allocation before recommending the participant (operation 428).

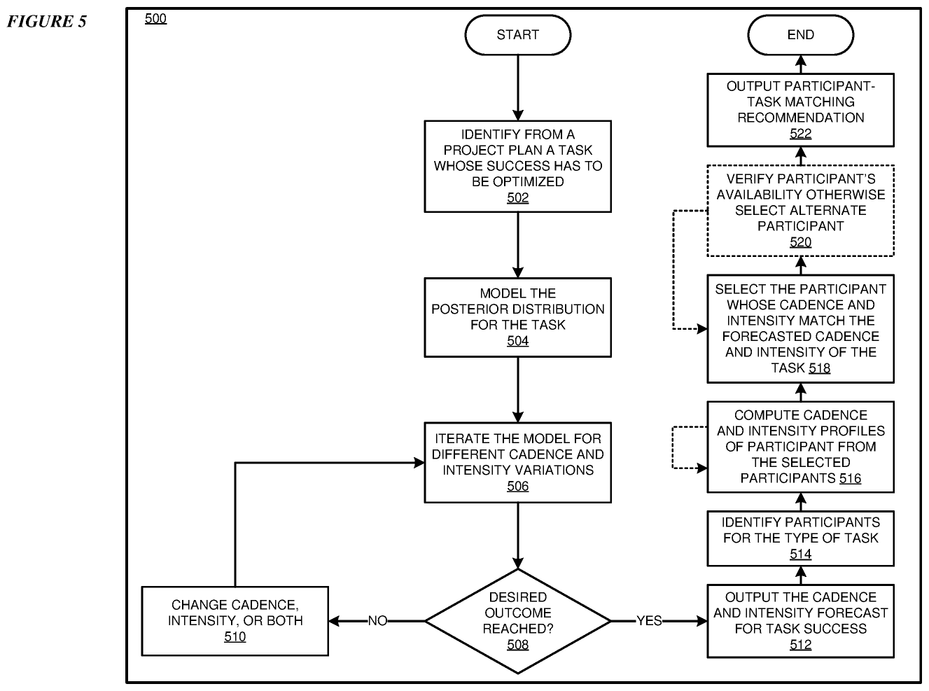

With reference to FIG. 5, this figure depicts a flowchart of an example process for task group formation using social interaction energy in accordance with an illustrative embodiment. Process 500 can be implemented in application 302 in FIGS. 3-4.

From a project plan, the application identifies a task whose success probability has be optimized (block 502). The application models the posterior distribution for the task using historical project data and current evidence in a manner described herein (block 504).

The application iteratively executes the model for different cadence and intensity values (block 506). The application determines whether a convergence between the prior and the posterior has been reached to indicate a desired optimal probability of success for the task (block 508). If the convergence has not been reached (“No” path of block 508), the application changes the cadence value, the intensity value, or both (block 510) and returns to block 506. If the convergence has been reached (“Yes” path of block 508), the application outputs the cadence and intensity as forecasted metrics for optimal probability of task success (block 512).

The application identifies a set of participants for the type of task (block 514). The application computes the cadence and intensity profiles of a participant from the set of participants (block 516). The application repeats block 516 for as many participants as may be present in the set.

The application selects that participant from the set whose cadence and intensity matches the optimal cadence and intensity computed by the model (block 518). Optionally, the application verifies whether the selected participant is available according to a resource allocation information source (block 520). If the selected participant is unavailable for allocating to the task, the application selects a different matching participant who is available at block 518.

The application outputs a recommendation to allocate the selected participant to the task (block 522). The application ends process 500 thereafter.

Thus, a computer implemented method, system or apparatus, and computer program product are provided in the illustrative embodiments for task group formation using social interaction energy and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, including but not limited to computer-readable storage devices as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
constructing a prediction model specific to a type of a task in a project;
adjusting, during an execution of the prediction model, a cadence metric to a first value, the adjusting causing a posterior of the prediction model to converge with a prior of the prediction model;
determining that the first value of the cadence metric causes the probability of success of the type of the task to reach a desired value;
profiling a set of participants using historical participation data, the profiling producing a cadence profile of each participant in the set of participants;
matching a value in the cadence profile of a selected participant with the first value of the cadence metric; and
causing a project planning tool to allocate the selected participant as a resource for the task of the type.

2. The method of claim 1, further comprising:
constructing a first prior from historical success data of a previous task of the type;
constructing a conjugate using a second value of the cadence metric, the second value of the cadence metric being a current value of social interaction cadence in a current state of the task; and
establishing a posterior distribution of the prediction model as a function of the prior and the conjugate, wherein a convergence of the posterior and the prior of the prediction model occurs in an iteration of the execution, the posterior at convergence indicating an optimal probability of success of the task with the second value of the cadence metric.

3. The method of claim 1, further comprising:
constructing a first prior from historical success data of a previous task of the type;
constructing a conjugate using a current value of an intensity metric, the current value of the intensity metric being a current value of social interaction intensity in a current state of the task; and
establishing a posterior distribution of the prediction model as a function of the prior and the conjugate, wherein a convergence of the posterior and the prior of the prediction model occurs in an iteration of the execution, the posterior at convergence indicating an optimal probability of success of the task with a revised value of the intensity metric.

4. The method of claim 1, wherein the cadence metric comprises a measurement of a frequency of social interactions by a participant in performance of the task.

5. The method of claim 1, wherein the cadence metric comprises a pattern of frequencies of social interactions over a period by a participant in performance of the task, and wherein a duration of the task spans a plurality of patterns.

6. The method of claim 1, further comprising:
adjusting, during an execution of the prediction model, an intensity metric to a first value, the adjusting causing a posterior of the prediction model to converge with a prior of the prediction model.

7. The method of claim 6, wherein the intensity metric comprises a measurement of a level of detail of social interactions by a participant in performance of the task.

8. The method of claim 6, wherein the v metric comprises a pattern of levels of details of social interactions over a period by a participant in performance of the task, and wherein a duration of the task spans a plurality of patterns.

9. The method of claim 1, wherein the historical participation data is historical data of the selected participant from participation in a previous task of the type.

10. The method of claim 1, wherein the historical participation data is historical data of a different participant from participation in a previous task of the type, and wherein the different participant and the selected participant have a common characteristic.

11. The method of claim 1, further comprising:
additionally profiling the set of participants using the historical participation data, the additionally profiling producing an intensity profile of each participant in the set of participants.

12. The method of claim 1, further comprising:
determining that a value in a cadence profile of a first participant matches the first value first value of the cadence metric; determining, from a resource allocation information, that the first participant is pre-allocated to a different task; and
selecting the selected participant responsive to the first participant being pre-allocated.

13. The method of claim 1, wherein the causing the project planning tool to allocate is responsive to a recommendation output to the project planning tool.

14. A computer usable program product comprising a computer-readable storage device, and program instructions stored on the storage device, the stored program instructions comprising:
program instructions to construct a prediction model specific to a type of a task in a project;
program instructions to adjust, during an execution of the prediction model, a cadence metric to a first value, the adjusting causing a posterior of the prediction model to converge with a prior of the prediction model;
program instructions to determine that the first value of the cadence metric causes the probability of success of the type of the task to reach a desired value;
program instructions to profile a set of participants using historical participation data, the profiling producing a cadence profile of each participant in the set of participants;
program instructions to match a value in the cadence profile of a selected participant with the first value of the cadence metric; and
program instructions to cause a project planning tool to allocate the selected participant as a resource for the task of the type.

15. The computer usable program product of claim 14, further comprising:
program instructions to construct a first prior from historical success data of a previous task of the type;
program instructions to construct a conjugate using a second value of the cadence metric, the second value of the cadence metric being a current value of social interaction cadence in a current state of the task; and
program instructions to establish a posterior distribution of the prediction model as a function of the prior and the conjugate, wherein a convergence of the posterior and the prior of the prediction model occurs in an iteration of the execution, the posterior at convergence indicating an optimal probability of success of the task with the second value of the cadence metric.

16. The computer usable program product of claim 14, further comprising:
program instructions to construct a first prior from historical success data of a previous task of the type;
program instructions to construct a conjugate using a current value of an intensity metric, the current value of the intensity metric being a current value of social interaction intensity in a current state of the task; and
program instructions to establish a posterior distribution of the prediction model as a function of the prior and the conjugate, wherein a convergence of the posterior and the prior of the prediction model occurs in an iteration of the execution, the posterior at convergence indicating an optimal probability of success of the task with a revised value of the intensity metric.

17. The computer usable program product of claim 14, wherein the cadence metric comprises a measurement of a frequency of social interactions by a participant in performance of the task.

18. The computer usable program product of claim 14, wherein the computer usable code is stored in a computer readable storage device in a data processing system, and wherein the computer usable code is transferred over a network from a remote data processing system.

19. The computer usable program product of claim 14, wherein the computer usable code is stored in a computer readable storage device in a server data processing system, and wherein the computer usable code is downloaded over a network to a remote data processing system for use in a computer readable storage device associated with the remote data processing system.

20. A computer system comprising a processor, a computer-readable memory, and a computer-readable storage device, and program instructions stored on the storage device for execution by the processor via the memory, the stored program instructions comprising:
program instructions to construct a prediction model specific to a type of a task in a project;
program instructions to adjust, during an execution of the prediction model, a cadence metric to a first value, the adjusting causing a posterior of the prediction model to converge with a prior of the prediction model;
program instructions to determine that the first value of the cadence metric causes the probability of success of the type of the task to reach a desired value;
program instructions to profile a set of participants using historical participation data, the profiling producing a cadence profile of each participant in the set of participants;
program instructions to match a value in the cadence profile of a selected participant with the first value of the cadence metric; and
program instructions to cause a project planning tool to allocate the selected participant as a resource for the task of the type.
